(19) United States
(12) Patent Application Publication
(10) Pub. No.: US 2010/0138253 A1
(43) Pub. Date: Jun. 3, 2010

(54) All aspect quantification system for the risk rating of operating errors for an advanced boiling water reactor

(76) Inventors: CHUN-CHANG CHAO, Taoyuan County (TW); Meng-Chi Cehn, Taoyuan County (TW)

Correspondence Address: MICHAEL LIN, 5F 79 Roosevelt Rd. Sec. 2, TAIPEI, 106, TW

(21) Appl. No.: 12/326,871

(22) Filed: Dec. 2, 2008

(51) Int. Cl. G06Q 50/00

(52) U.S. Cl. 705/7

(57) ABSTRACT

Based on the discovered operating errors under all basic operating mode s for advanced boiling water reactor, a suitable quantification analytical model is employed to fast assess the risk situation for the discovered operating errors and quantified results are used to differentiate the risk rating for the operating errors. This is used to determine the necessity and urgency for the corrective measures to respond to the errors. The adopted quantification analytical model is the safety assessment (Probabilistic Risk Assessment, PRA) model for all basic operating mode s for advanced boiling water reactor, including power operation, low power operation and shutdown for major repairs. For the discovered operating error during power operation period, the invention uses the specifically developed safety assessment model for plant event, earthquake, flood and fire to determine risk effect for the discovered operating error on different event to manifest the risk characteristics for the discovered operating error and match the quantification results to existing plant design, operation and maintenance conditions.

### BACKGROUND OF THE INVENTION

1. Field of the Invention

The invention is aimed at the discovered operating errors under all operating mode s for an advanced boiling water reactor, and employs a suitable configuration for quantification analysis to fast assess the risk with discovered operating errors, and uses the quantified result to differentiate the risk rating for operating errors, and assesses the necessity and urgency for improvement measures taken to correct the operating errors. The employed quantification model contains the Probabilistic Risk Assessment (PRA) model for all operating mode s for an advanced boiling water reactor, including power operation, low power operation and shutdown for major repairs etc. For operating errors discovered during power operation period, the developed specific safety assessment models to plant event s like earthquake, typhoon, flood and fire are employed. It is to consider extensively the risk effects of discovered operating errors on different event s. It is expected that the risk characteristics with the discovered operating errors be emphasized and the quantification results match present power plant design, operation and maintenance.

2. Description of the Prior Art

Safety assessment technique is a risk quantification analytical technique accountable by risk-related industries. Nuclear power plant has its operation intimately influential to the surrounding environment and residents, so it is the most successful industry that adopts safety assessment technique. Since nuclear power administration and nuclear power producers seriously emphasize the development and applications for safety assessment technology, most nuclear power plants have the safety assessment model to analyze the characteristics of their own plant design, operation and maintenance and this is required when they apply and renew their license and conduct related safety analysis. Safety assessment has the feature to perform a detail simulation of plant operation and design and its quantification result usually has the relative representation. Living safety assessment can reveals the instant operation characteristics for a power plant. So it is the most recognized quantification analysis model by the administration authorities and the nuclear power plants in the world.

Limited to the high demand of professional knowledge, the application of safety assessment technology to quantification risk assessment for a nuclear power plant has not been able to be widely spread to the nuclear power industry personnel in all aspects, including operation, maintenance, analysis, management and control. As a consequence, when a nuclear power plant discovers a specific operating error, it usually needs safety assessment specialists to perform tedious quantification task. The decision makers in management or control rely on their own professional knowledge and experience to pre-determine the importance of the discovered error. Although over-conservative decision tends to be advantageous to maintaining operation safety for a nuclear power plant, it could sacrifice operating performance for a nuclear power plant and even the overall economic value. The risk associated with operating errors due to lacking professional knowledge or experience is manifested by missing the timing of taking corrective measures and ends in losing the assurance of operating safety for a nuclear power plant.

### SUMMARY OF THE INVENTION

To set the safety quantification benchmark for a nuclear power plant, it is usually to use the core damage frequency (CDF) and large early release frequency (LERF) calculated by the safety assessment model as risk indicators. CDF is a risk indicator for power plant damage, while LERF is an indicator for the significant effect of a nuclear power plant on surrounding environment and residents.

Since the basic operating modes for advanced boiling water reactors vary differently. For the three major nuclear power plant operating mode s, power operation, low power operation and shutdown for major repairs, there are specific safety assessment models developed for each individual configuration based on operation characteristics and assumption. They are used to quantify risk indicators. Besides, each operating mode has very different quantification process. Especially the power operation configuration accounts for higher risk ratio, so it usually considers non-equipment related event s that are not related to equipment operation, such as earthquake, flood and fire, as well as equipment related event s. The professional ability needed for the quantification process for the hazard analysis involving non-equipment related event s is even more important than equipment related events.

To resolve the issue with a person who is not safety assessment specialist and fails to correctly and fast quantify the needed risk indicator and further extend the application of quantification risk assessment for nuclear power plant to all nuclear power energy personnel, the invention converts all safety assessment models that are suitable for individual operation configuration for an advanced boiling water reactor into an integrated quantification system for operating error risk rating for all aspects. Through a simple and concise user interface, hazard quantification engine and instant solution engine for safety assessment model, the nuclear power plant personnel involved in operation, maintenance, analysis, management and control can determine the importance level for the risk of operating errors in a short time without needing complete professional knowledge for safety assessment. The detail assessment results in great consistency in assessment process and results among different personnel.

The all-aspect quantification system for operating error risk rating for an advanced boiling water reactor is able to provide a consistent risk indicator and operating error risk rating. Therefore the auditors from the control unit or decision makers from the operation unit can use the rated risk indicator to further gain risk concept for abnormal operation and deterioration of systems and modules in a power plant and develop responsive control and administrative measures. This will have profound influence and benefits to improving control openness and transparency.

### BRIEF DESCRIPTION OF THE DRAWINGS

FIG. 1 is the process flow diagram for the all-aspect operating error risk rating quantification system for advanced boiling water nuclear power plant in the invention.

### DETAILED DESCRIPTION OF THE INVENTION

The all-aspect quantification system for operating error risk rating for an advanced boiling water reactor adopts all specific safety assessment models to each basic operation configuration for an advanced boiling water reactor and converts the operating errors that would be discovered by analytical personnel into corresponding equipment deterioration, system availability, event frequency and common equipment availability change by the safety assessment model. The combination of all changes will be considered as a new power plant configuration that is different than normal operation. To quantify risk indicators, it starts with hazard quantification engine to re-calculate the new configuration and the specific event frequency, and it uses the instant solution engine of the safety assessment model and the new plant configuration to quantify all related safety assessment, and then it calculates the two risk indicators, CDF and LERF, for the new plant configuration.

Risk rating is determined by the increase in CDF and LERF. The increase can be calculated by Equation [1] and Equation [2]:

CDF=Σ_{j,j=1˜14}[(CDF_{i,j}−CDF_{b,j})×(T_{i,j}/T_{b,j})]; Equation [1]

LERF=Σ_{j,j=1˜14}[(LERF_{i,j}−LERF_{b,j})×(T_{i,j}/T_{b,j})]; Equation [2]

CDF and LERF in Equation [1] and Equation [2] use two subscripts to show their meaning. If the first subscript is i, it represents the risk value calculated from the new plant configuration. If the first subscript is b, it represents the risk value for normal operation. The second subscript represents one of the 14 basic operation configurations for the normal operation for an advanced boiling water reactor. The basic operation configurations for individual codes are shown in Table 1. Operation symbol Σ_{j,j}=1˜14 represents summing up the results from all the 14 basic operation configurations.

TABLE 1
Configuration Classification for Advanced Boiling Water Reactor

| Basic | | | |
|---|---|---|---|
| Operation | | | |
| Configuration | Analytical | Configuration | Initial Condition for |
| Code (j) | Procedure | Classification | Configuration Change |
| 1 | 3.1 | Power | Core thermal power higher |
| | | operation | than 25% |
| 2 | 4.1.1 | Low power | Core thermal power lower |
| | | operation | than 25% |
| 3 | 4.1.2 | (Load | Generator disconnection |
| | | decreasing) | |
| 4 | 5.1.1 | Shutdown for | Shutdown to start cooling |
| 5 | 5.1.2 | major repairs | RCIC isolation off |
| 6 | 5.1.3 | | RPV top cover screw |
| | | | loosening |
| 7 | 5.1.4 | | Cavity water level full |
| 8 | 5.1.5 | | Cavity starts draining |
| 9 | 5.1.6 | | RPV top cover installation |
| | | | completed |
| 10 | 5.1.7 | | Cooling stops and core |
| | | | starts increasing |
| | | | pressure |
| 11 | 5.1.8 | | Core pressure release |
| | | | completed, and shutdown to |
| | | | re-start cooling |
| 12 | 4.1.3 | Low power | Cooling stops and feed |
| | | operation | water starts building up |
| 13 | 4.1.4 | (Load | RCIC available |
| 14 | 4.1.5 | increasing) | Generator parallel |

For the plant configuration j applicable to a specific operating error, CDF_{b,j} and LERF_{b,j} represent the risk indicators under normal operation. After the user completes the power plant configuration setting, the all-aspect risk rating quantification system for operating errors in an advanced boiling water reactor can calculate the risk indicator, CDF_{i,j} and LERF_{i,j}, under the new power plant configuration through hazard quantification engine and safety assessment instant solution engine. T_{i,j} in the equation represents the duration for the operating error under a specific power plant configuration, while T_{b,j} is the average duration for the specific power plant configuration. Since some operating errors are not applicable to a specific power plant configuration, it is necessary to calculate the risk indicators, CDF_{i,j} and LERF_{i,j}, for all the operation configurations which the operating errors are applicable to. In the end, all the calculation results sum up to obtain the overall risk indicator change, which is an important reference for risk rating quantification.

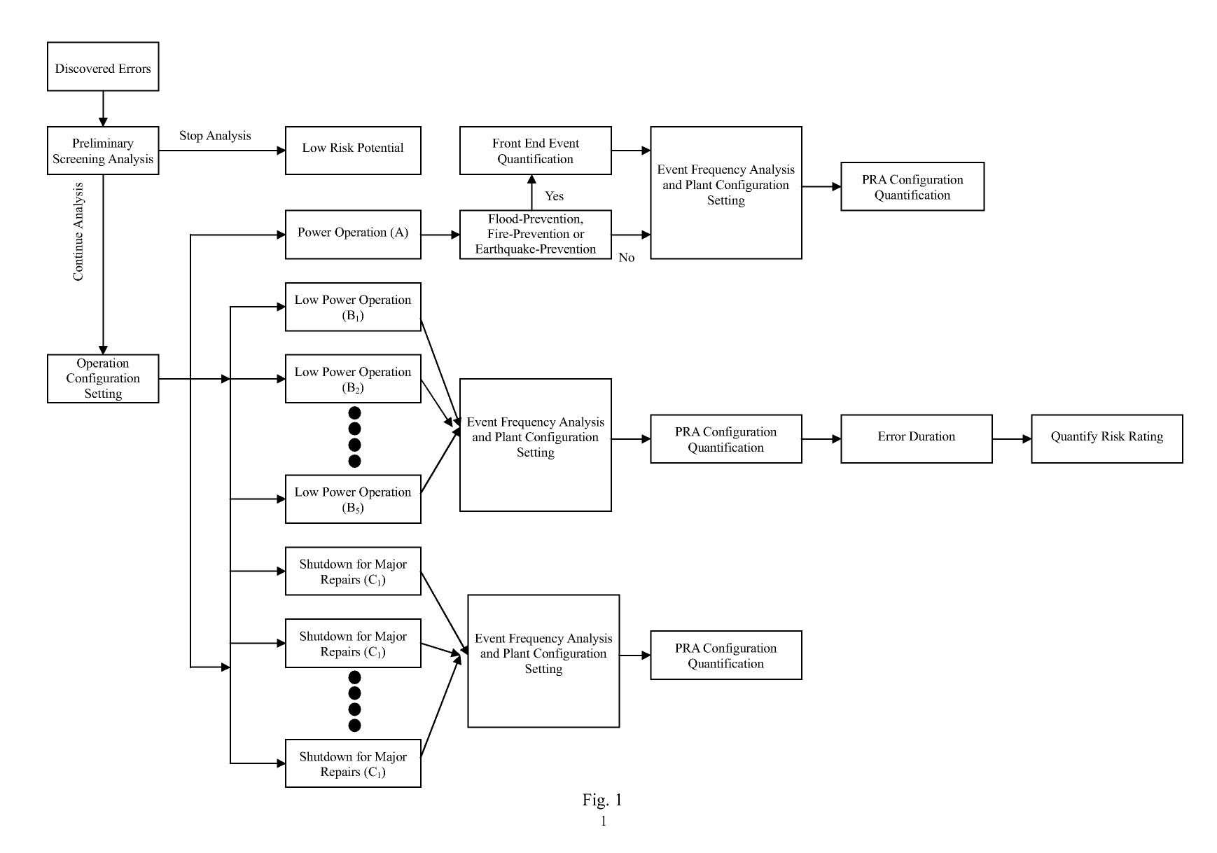

FIG. 1 is the process flow diagram for the all-aspect operating error risk rating quantification system for advanced boiling water reactor. For unspecified power plant operation configurations, system deterioration and equipment malfunction, the all-aspect operating error risk rating quantification system can quantitatively exclude the errors irrelevant to power plant operation. These operating errors will be corrected according to existing regulations or administrative measures, but not involved in the subsequent risk rating assessment. The following describes the tasks for each step in the process flow diagram.

### Step 1.1˜1.2: Perform Preliminary Screening Analysis

The objective for preliminary screening analysis is to eliminate the operating errors irrelevant to power plant operation. These operating errors will not cause any event s concerned by the safety assessment model. System or equipment deterioration caused by these operating errors will not increase the two risk indicators, CDF and LERF. Practically, in step 1.1 the discovered operating error is first checked against the specifically developed power plant configuration list for advanced boiling water reactor, and then if it matches any configuration in the list it will be determined as potential risk to power plant operation and it will be necessary to perform further risk quantification; if the discovered operating error does not match any configuration in the list, the operating error will be determined as risk-free and the analytical task will advance to 1.2 without the need of further risk quantification.

### Step 2: Set Up Operating Mode

According to the classification of event s by safety assessment model and the success criteria setting by safety system, power plant with advanced boiling water reactor can be distinguished in Table 1 by 14 operation configurations. Each operation configuration has its own safety assessment model developed specifically for its characteristics. Each operation configuration is differentiated by core power into three categories, power operation, low power operation and shutdown for major repairs. During low power operation and shutdown for major repairs periods, due to large change in system availability and core cooling mode, they are further classified into 5 and 8 operation configurations respectively. The user can select one or continuously several operation configurations based on the timing and duration for the discovered operating error. All-aspect operating error risk rating quantification system will perform assessment on individual risk indicator change for all the selected operation configurations.

### Step 3.1: Select Power Operation Plant Configuration

During power operation period, the safety assessment model with respects to the major risk sources for advanced boiling water reactor includes different analytical models like plant event s, flood, fire and earthquake. When the operation configuration selected by the user in Step 2 includes power operation period, all-aspect operating error risk rating quantification system will use the four safety assessment models as quantification target, plant event s, flood, fire and earthquake.

### Step 3.2: Determine Whether Operating Error is Related to Fire-Prevention, Flood-Prevention or Earthquake-Prevention Facilities

Since to quantify the safety assessment on flood, fire and earthquake during power operation it needs to perform the front-end event tree quantification first, the step will prompt the user to determine whether the discovered operating error is related to fire-prevention, flood-prevention and earthquake-prevention facilities. If it is, it is necessary to perform Step 3.3 for front-end event tree quantification.

### Step 3.3: Quantify Front-End Event Tree

When the user determines in Step 3.2 the discovered operating error is related to fire-prevention, flood-prevention and earthquake-prevention facilities, it is necessary to perform front-end event tree quantification in the step. For power operation flood, fire and earthquake safety assessment models have their own specific front-end event tree to quantify the frequency for each critical configuration when plant equipment or module fails after flood, fire or earthquake during power operation period. The front-end event tree quantification engine in the all-aspect operating error risk rating quantification system will use the revised power plant configuration on the discovered operating error to re-calculate the frequency for each power plant configuration as the input data to enter in Step 3.5 for power operation safety assessment quantification.

For errors related to flood-prevention, the user can update the abnormal conditions for the specific area for the frequency of flood and the flood-prevention function for flood-prevention gate, water level meter, water drainage facility and flood alarming; for errors related to fire-prevention, the user can update the abnormal conditions for the specific areas for the frequency of fire and the fire-prevention functions for fire-prevention gate, fire-prevention system, fire detection system and fire alarming; for errors related to earthquake, the user can update the earthquake hazard curve that is related to earthquake intensity and frequency for the plant site and the earthquake resistance for the building, system and equipment.

### Step 3.4: Analyze Event Frequency and Set Power Plant Configuration

Based on the discovered errors by the user, the step revises system configuration (like system unavailability or system reliability decrease) and event frequency and equipment status (like system unavailability or system reliability decrease). The system configuration and equipment status update refers to the general system and equipment used by the advanced boiling water reactor during normal power period and the spare safety system that would be used to alleviate the event. The frequency of event also refers to the general emergency shutdown related to equipment operation in a common plant event. Updating the power plant configuration in this step does not need to go through the front-end event tree quantification model in Step 3.3 and is applicable to quantification for four different analytical models for plant event, flood, fire and earthquake.

### Step 3.5: Quantify Power Operation Safety Assessment Model

Based on the defined power plant configuration change by Step 3.3 and Step 3.4, the step selects the four safety assessment models for power operation plant event, flood, fire and earthquake to re-quantify risk and calculate the CDF_{i,j} and LERF_{i,j} in Equation [1] and Equation [2]. To expedite quantification process and prevent errors due to data entry mistakes in revising the model, in all safety assessment models it is necessary to convert the event trees, failure trees, databanks and parameters and calculation rules required by quantification into specific input models for instant risk solution engine INERISKEN and then INERISKEN will perform fast calculation for the two risk indicators, CDF and LERF.

### Step 4.1.1˜4.1.5: Select Low Power Operation Power Plant Configuration

As shown in Table 1, during the low power operation period for advanced boiling water reactor there are five different power plant configurations including load decreasing and load increasing. Each power plant configuration has its own safety assessment model. All-aspect operating error risk rating quantification system uses the power plant operation configuration selected by the user in Step 2 to perform configuration setting change in Step 4.2 and safety assessment quantification in Step 4.3.

### Step 4.2: Analyze Event Frequency and Set Power Plant Configuration

Based on the operating error discovered by the user, the step revises the system configuration during low power operation period (such as system unavailable or system reliability decreasing), event frequency and equipment status (such as equipment unavailable or equipment reliability decreasing).

### Step 4.3: Quantify Low Power Operation Safety Assessment

Based on the power plant configuration changed defined in Step 4.2, the step uses the safety assessment model for the selected low power operation power plant configuration in Step 2 to re-quantify risk and calculate CDF_{i,j} and LERF_{i,j}. To expedite quantification process and prevent errors due to data entry mistakes in revising the model, in all safety assessment models it is necessary to convert the event trees, failure trees, databanks and parameters and calculation rules required by quantification into the designated input models for instant risk solution engine INERISKEN and then INERISKEN will perform fast calculation for the two risk indicators, CDF and LERF.

### Step 5.1.1˜5.1.8: Select Shutdown for Major Repairs Power Plant Configuration

As shown in Table 1, during the shutdown for major repairs period for advanced boiling water reactor there are 8 different power plant configurations. Each power plant configuration has its own safety assessment model. All-aspect operating error risk rating quantification system uses the power plant operation configuration selected by the user in Step 2 to perform configuration setting change in Step 5.2 and safety assessment quantification in Step 5.3.

### Step 5.2: Analyze Event Frequency and Set Power Plant Configuration

Based on the operating error discovered by the user, the step revises the system configuration during the shutdown for major repairs period (such as system unavailable or system reliability decreasing), event frequency and equipment status (such as equipment unavailable or equipment reliability decreasing).

### Step 5.3: Quantify Low Power Operation Safety Assessment

Based on the power plant configuration changed defined in Step 5.2, the step uses the safety assessment model for the selected low power operation power plant configuration in Step 2 to re-quantify risk and calculate CDF_{i,j} and LERF_{i,j}. To expedite quantification process and prevent errors due to data entry mistakes in revising the model, in all safety assessment models it is necessary to convert the event trees, failure trees, databanks and parameters and calculation rules required by quantification into the designated input models for instant risk solution engine INERISKEN and then INERISKEN will perform fast calculation for CDF.

### Step 6: Error Duration

The user in the step enters the error duration (T_{i,j}) selected in Step 2 for each power plant operation configuration. Based on the analytical assumption in safety assessment model, each power plant configuration has annual average duration to match the two risk indicators, CDF and LERF, which are expressed by annual frequency. In this step all-aspect operating error risk rating quantification system will provide the duration for each power plant operation configuration (T_{b,j}) as reference for the user to enter duration.

### Step 7: Quantify Risk Rating

After completion of the safety assessment model quantification in Step 3.5, Step 4.3 and Step 5.3, the quantification results will be used in Equation [1] and Equation [2] to calculate risk increase CDF and LERF. The based on the calculation result for risk increase CDF and LERF, the discovered operating error is assessed for risk rating. Table 2 shows the relationship between risk increase and risk rating. RISK represents CDF or LERF. When the rating value is higher, it means the discovered operating error has higher potential risk. After Equation [1] and Equation [2] are used to calculate risk increase CDF and LERF and determine risk rating, the larger risk rating is selected to be the final representative risk rating for the discovered operating error.

TABLE 2
Risk increase and risk rating

| Risk increase | Risk rating |
|---|---|
| R_{N} < RISK | N |
| . | |
| . | |
| . | |
| R₂ < RISK < R₃ | 2 |
| R₁ < RISK < R₂ | 1 |
| RISK < R₁ | 0 |

What is claimed is:

1. An operating error risk rating assessment method for advanced boiling water reactor comprises the following:
1) Determine whether the discovered operating error is the specific power plant configuration with risk potential for advanced boiling water reactor; if yes, proceed with subsequent risk assessment; if not, it is determined as risk free;
2) Classify the advanced boiling water reactor into power operation, low power operation and shutdown for major repairs;
3) In selection of power operation configuration, the safety assessment models include plant event, flood, fire and earthquake; prior to assessment it needs to determine whether the discovered operating error is related to fire-prevention, flood-prevention or earthquake-prevention facilities; if yes, proceed with the calculation in Step 4); if not, proceed directly to the calculation in Step 5);
4) When the user determines the discovered operating error is related to fire-prevention, flood-prevention or earthquake-prevention facilities, assess the power plant configuration for the discovered operating error and re-calculate the frequency for each configuration as the input data for power operation safety assessment;
5) Based on power plant configuration change and the safety assessment model for power operation configuration, calculate CDF_{i,j} and LERF_{i,j} in Equation [1] and Equation [2];
6) In selection of low power operation plant configuration, based on the safety assessment model for low power operation plant configuration, calculate CDF_{i,j} and LERF_{i,} in Equation [1] and Equation [2];
7) In selection of shutdown for major repairs plant configuration, based on the safety assessment model for shutdown for major repairs plant configuration, calculate CDF_{i,j} and LERF_{i,j} in Equation [1] and Equation [2];
8) After completion of safety assessment, based on safety rating calculate the risk increase, CDF and LERF, in Equation [1] and Equation [2], and then use the calculation results for CDF and LERF to assess the risk rating for the discovered operating error; select the larger risk rating as the final representative risk rating for the operating error.

2. According to the assessment method for the operating error risk rating for advanced boiling water reactor in claim 1, the safety rating calculation equations are as follows:
CDF=Σ_{j,j=1˜14}[(CDF_{i,j}−CDF_{b,j})×(T_{i,j}/T_{b,j})] Equation [1]
and
LERF=Σ_{j,j=1˜14}[(LERF_{i,j}−LERF_{b,j})×(T_{i,j}/T_{b,j})] Equation [2]
the two risk indicators, CDF and LERF, use the subscripts to represent their meaning; when the first subscript is i, it means the risk value calculated on the new power plant configuration; when the first subscript is b, it means the risk value under normal operation; the second subscript represents one of the fourteen basic operation configurations for the advanced boiling water reactor under normal operation; operation symbol Σ_{j,j=1˜14} represents the result when the calculation results for all 14 basic operation configuration sum up.
